(19) United States
(12) Patent Application Publication
(10) Pub. No.: US 2014/0208812 A1
(43) Pub. Date: Jul. 31, 2014

(54) CONSTRUCTIVE ARRANGEMENT APPLIED TO A LOCK

(71) Applicant: PADO S/A INDUSTRIAL COMERCIAL E IMPORTADORA, Sao Paulo (BR)

(72) Inventor: PEDRO DA SILVA FILHO, Sao Paulo (BR)

(73) Assignee: PADO S/A INDUSTRIAL COMERCIAL E IMPORTADORA, Sao Paulo (BR)

(21) Appl. No.: 13/934,961

(22) Filed: Jul. 3, 2013

(30) Foreign Application Priority Data
Jan. 30, 2013 (BR) 202013002263-8

(51) Int. Cl. E05B 15/00

(52) U.S. Cl. CPC E05B 15/00
USPC 70/266

(57) ABSTRACT

It describes the patent of the utility model belonging to the field of products that block or prevent access to a particular area or thing, consisting of a body (1) made of anti-flame plastic, comprising a cylindrical curved metal rod (2), internally locked by two plastic tabs (3) orthogonally fitted, so that said tabs (3) are moved by a zamac trigger (4), which has a predominantly cylindrical shape, consisting of channels in the base which engage in the cylinder (5) for opening and closing located just below. Said cylinder (5) is fixed to the main body by means of a screw (6) and nut (7). The lower cover (8) of the lock is made of anti-flame plastic. The shape of the plastic tabs (3) is predominantly trapezoidal and they have a verve (9) for engaging the guide axis (10) of the trigger (4), and they have, at one end, an is inclined and curved face (11) that facilitates sliding on the recesses (12) for locking the metal rod (2).

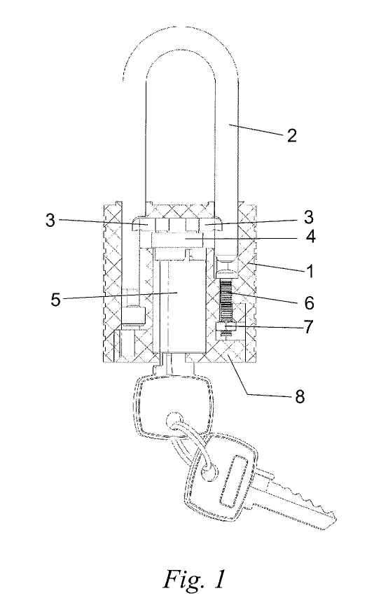

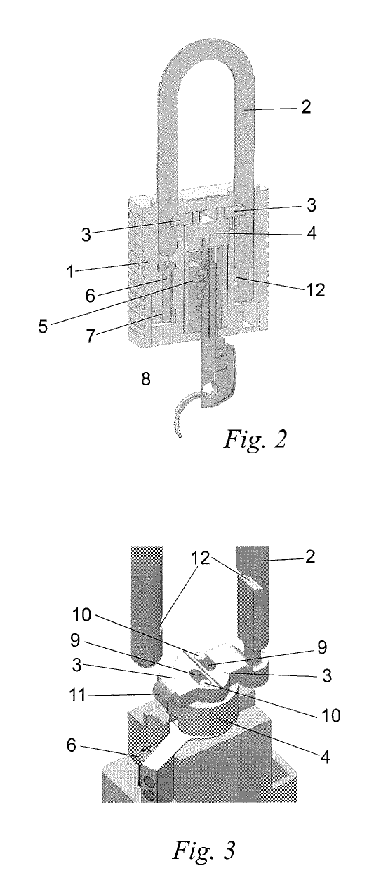

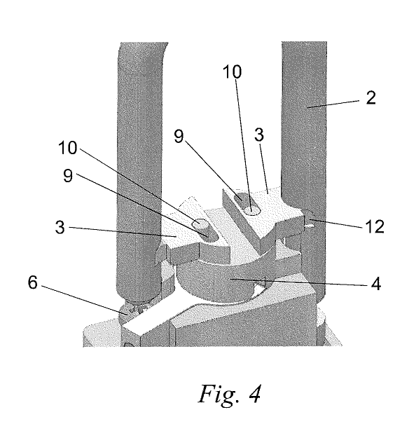

This report describes the patent of the utility model of a new constructive arrangement applied to a lock, provided with a locking set formed by plastic tabs, used for its opening and closing. This model was specifically designed to be used in places where there may be some risk to the user concerning electrical conductivity. It has an innovative design and important technological and functional improvements, according to the most modern engineering concepts and in compliance with the required standards and specifications. It has its own characteristics and fulfills the basic requirements of novelty and inventive act, resulting in a series of extraordinary technical, practical and economic advantages.

There are several models of locks currently in the market. However, as those skilled in the art know, there are times when the lock is used to close, for example, electric power command board devices, so there is a possibility that the user receives electric shocks due to the electrical conductivity.

In this sense, some inventors devised the locks of the patent documents listed below, but disregarded the insulation.

### STATE OF THE ART

The document of the patent MU8801567-0, deposited on Jun. 20, 2008, titled constructive arrangement applied to locks shows a lock covered by a metallic layer, providing a complete shield to the system and an easy assembly. The purpose of this utility model comprises a lock fitted with a split inner body, injected, in one piece, into zamac or some other metallic or nonmetallic material, formed by faces A and B. Face A illustrates the cavities internally, in order to accommodate the cylinder and latch, pins or code tabs, respectively, showing, from the top, the upper part with holes that receive the latch and, from the sides, walls that fit the face (B). Face B also illustrates the internal cavities completing the cylinder area and the lock, pins or code tabs. On the sides, it has engaging areas that form, with the union of faces A and B, the split inner body (C), injected in one piece into zamac or some other metallic or nonmetallic material. Finally, the split inner body (C) is covered by a patterned metallic layer (D) that has cut-outs for the passage of the latch and a lower cut-out to access the key cylinder, being subsequently welded, which makes the proposed lock totally unbreakable.

The document of the patent MU8502490-2 deposited in Nov. 1, 2005 titled constructive arrangement introduced into locks shows a lock that comprises a lock composed of a solid body equipped with a latch that can be locked through the action of conventional internal mechanisms operated by a conventional key. The difference between and the state of the art is that the lock comprises, in its body, a through hole, which is made to establish an condition of alignment with a corresponding through hole on the free end of the latch; said holes, when aligned, define a channel through which the cable of a safety seal can cross.

The document of the patent PI9802268-7 deposited in Jun. 5, 1998 titled lock improvement describes a product that basically comprises a metal body internally equipped with three tubular housings, parallel and adjacent to each other. The external housings, with the same diameter, extend from the upper face of the lock body and are designed for the axial engagement of the respective ends of a lock rod shaped like a semi-elliptical arc, while the intermediate housing, that extends from the lower face of the body of the lock, is designed for the axial engagement of the core lock that locks with the locking rod through a transversal mechanism.

The locking rod may be replaceable, enabling a selective assembly of different types of locking rods in the same shielded body of the lock. The lock core is likewise selectively assembled in the body of the lock. Its transverse locking mechanism works with the locking rod at the free end when it is engaged to the retaining housing defined in the lock body.

Analyzing the documents mentioned above, which are known in the art, as we will see, none of them has all the constructive characteristics addressed in the present invention, related to the locking tabs set for opening and closing the lock.

Consequently, studies have been conducted over time aiming to eliminate all these problems and setbacks. As a result, this model has been developed, enabling the design of a new constructive arrangement applied to the lock with plastic tabs to lock the rod, and the trigger of the tabs made of zamac, creating the possibility to protect users by insulating the electrical current when they are used, for example, in distribution boards. The locking system was also improved, resulting in an integrated product with real possibilities of economical industrialization, cost reduction, manufacturing time and workforce expenses. It also brought preciseness to the assembly, with better results and high safety standards.

Therefore, this patent of utility model aims to provide a locking mechanism that uses tabs for electrical insulation. The locking system of the hook is made of two plastic tabs and a zamac trigger that will displace the tabs to release the hook or lock. As to the electrical insulation, the solution is to use polymer material to produce the locking tabs, thereby creating a barrier between the internal components of the lock, manufactured in metal, isolating the metal hook of the metal key, and preventing electrical conductivity in the lock. The locking tabs of the rod are made of polymer, preventing that electrical current passes through the metal hook and to the key, which is also metallic. Such insulation happens because of the internal mechanism in which in a normal lock is totally manufactured in metal, and, in this lock there is a component that isolates the metals from one another.

These and other objectives are attained with an arrangement that comprises a body made of anti-flame retardant plastic and consisting of a cylindrical bent metal rod. Internally, the rod is locked by two orthogonally-installed plastic tabs, so that such tabs are moved by a zamac trigger, which has predominantly cylindrical shape, and has channels on the base which engage the cylinder for opening and closing located immediately below.

The cylinder previously mentions is fixed to the main body by means of screws and nuts, and the lower cover of the lock is made of anti-flame plastic.

The shape of the plastic tabs is predominantly trapezoidal and they have a verve to engage the guide axis of the trigger. They also have, on one end, a curved and inclined face that facilitates the sliding on the locking recesses of the metal rod.

To complement this description, in order to better understand the characteristics of the invention, and in accordance with a preferred embodiment thereof, a set of drawings is attached hereto that exemplifies, but does not limit, the following representations:

Drawing 1 is a sectional elevation view of the lock of the present invention;

Drawing 2 is a perspective view of the internal part of the lock of the present invention;

Drawing 3 is a partial perspective view of the internal part of the lock of the present invention, highlighting the locking tabs;

Drawing 4 is another partial perspective view of the internal part of the lock of the present invention, highlighting the locking tabs.

These and other objectives are attained with an arrangement that comprises an anti-flame plastic body (1) composed of a cylindrical curved metal rod (2), that is locked by two plastic tabs (3) orthogonally installed, so that such tabs (3) are moved by a trigger (4) of zamac, which has predominantly cylindrical shape, and has channels on the base that engage in the cylinder (5) for opening and closing located just below.

That cylinder (5) is fixed to the main body by means of a screw (6) and nut (7), and the lower cover (8) of the lock is made of anti-flame plastic.

The shape of the plastic tabs (3) abovementioned is predominantly trapezoidal and they have a verve (9) to engage the guide axis (10) of the trigger (4), and they have, at one end, an inclined and curved face (11) that facilitates the sliding on the recesses (12) for locking the metal rod (2).

We are not aware of the existence of any locking tabs of lock rods that meet all the constructive and functional characteristics reported above, and that directly or indirectly, is or was as effective as the tabs of the present invention.

It is obvious to those skilled in the art that, even though this document describes the preferred embodiment of the invention, any modifications and/or changes must be understood as within the scope of the patent of the utility model that fits perfectly in the criteria that define it, i.e., the combination and modification of known elements in a new form or arrangement, involving an inventive act, resulting in functional improvement of its use or manufacture.

1. (canceled)

2. A lock arrangement comprising:
a main body made of flame resistant plastic;
a cylindrical curved metal rod movably mounted in the main body between an open position and a closed position;
a pair of plastic tabs mounted in the main body and movable orthogonally relative to the cylindrical curved metal rod between an open position in which the cylindrical curved metal rod is free to move and a closed position in which the pair of plastic tabs contacts the cylindrical curved metal rod to lock it in place;
a cylinder rotatably mounted in the main body and operably connected to the pair of plastic tabs to move the plastic tabs orthogonally; and
a plastic lower cover mounted on a bottom of the main body.

3. The lock arrangement of claim 2, further comprising a trigger mounted in the main body and connected between the cylinder and the pair of plastic tabs such that the trigger rotates with the cylinder and moves the plastic tabs orthogonally.

4. The lock arrangement of claim 3, wherein the trigger is cylindrical in shape and further comprises:
a first end adjacent the cylinder with a channel formed therein receiving a protrusion of the cylinder; and
a second end adjacent to the pair of plastic tabs with a pair of axial posts extending therefrom and interacting with the pair of plastic tabs.

5. The lock arrangement of claim 4, wherein each tab of the pair of plastic tabs includes a slot configured to receive a respective post of the pair of posts of the trigger such that rotation of the trigger with the cylinder moves the pair of tabs orthogonally.

6. The lock arrangement of claim 5, wherein the trigger is made of zamac.

7. The lock arrangement of claim 2, wherein the each plastic tab of the pair of tabs is substantially trapezoidal in shape.

8. The lock arrangement of claim 2, wherein each plastic tab of the pair of plastic tabs includes a curved face positioned facing the cylindrical curved metal rod.

9. The lock arrangement of claim 8, wherein the cylindrical curved metal rod includes at least one recess formed at an end thereof adjacent to at least one plastic tab of the pair of plastic tabs and shaped to receive the curved face of the plastic tab when the plastic tab is in the locked position
